(19) United States
(12) Patent Application Publication
(10) Pub. No.: US 2016/0334567 A1
(43) Pub. Date: Nov. 17, 2016

(54) PLANAR ILLUMINATION DEVICE AND LIQUID CRYSTAL DISPLAY DEVICE

(71) Applicant: MINEBEA CO., LTD., Kitasaku-gun (JP)

(72) Inventor: Toru KUNIMOCHI, Fukuroi-shi (JP)

(73) Assignee: MINEBEA CO., LTD., Kitasaku-gun (JP)

(21) Appl. No.: 15/144,298

(22) Filed: May 2, 2016

(30) Foreign Application Priority Data
May 11, 2015 (JP) 2015-096600

(51) Int. Cl. F21V 8/00

(52) U.S. Cl. CPC G02B 6/0088

(57) ABSTRACT

A planar illumination device according to an embodiment includes a light guiding plate, a light source, an optical sheet and a frame. The light guiding plate has one of a pair of opposite principal surfaces serving as a light emission surface. The light source is arranged at a side surface. The optical sheet is arranged on a side of the light emission surface. The frame includes a side wall arranged along a side surface and has an overlap portion formed therein, where the optical sheet and the side wall of the frame overlap each other at least partially and where an upper end surface of the side wall is arranged below a lower surface of the optical sheet and covered by the optical sheet at least partially. The adhesive sheet is stuck over an upper surface of the optical sheet and an outer surface of the side wall.

### CROSS-REFERENCE TO RELATED APPLICATION(S)

The present application claims priority to and incorporates by reference the entire contents of Japanese Patent Application No. 2015-096600 filed in Japan on May 11, 2015.

### BACKGROUND OF THE INVENTION

1. Field of the Invention

The present invention relates to a planar illumination device including an optical sheet arranged on an emission surface side of a light guiding plate and a frame for positioning at least the light guiding plate, and to a liquid crystal display device using this planar illumination device.

2. Description of the Related Art

At present, liquid crystal display devices are generally used as display devices of electronic devices, such as personal computers and mobile phones. Liquid crystal is not a spontaneous light emitting type display element, and thus planar illumination devices serving as illuminating means are widely used in combination with liquid crystal display devices.

A schematic configuration of a liquid crystal display device 100 including such a planar illumination device is, as illustrated in FIG. 4, formed of, a liquid crystal display panel (LCD) 110, and a planar illumination device 101 arranged on a reverse surface side of the LCD 110. The planar illumination device 101 includes, as components thereof: a light guiding plate 12, which is formed of a synthetic resin material, has one (surface) of a pair of opposite principal surfaces serving as a light emission surface, and is rectangular in a planar view thereof; a reflecting sheet 118 arranged on a reverse surface side of the light guiding plate 12; and plural plate shaped (or sheet shaped) members, such as optical sheets 18 of plural layers (three layers in the example in FIG. 4) arranged between the LCD 110 and the light guiding plate 12. Inside a frame 124, which is, in the example in FIG. 4, formed of a synthetic resin material and frame shaped, these components are stored, together with a light source, such as a white LED, which is arranged opposite to a side surface (light incident surface) of the light guiding plate 12, the side surface connecting end edges of the pair of principal surfaces. As described above, the liquid crystal display device 100 is formed by this planar illumination device 101 and the LCD 110 being integrally combined with each other.

In this liquid crystal display device 100, conventionally, a light shielding sheet 20 prescribing an effective area of the emission surface is also used as a means to fix the optical sheets 18 and the LCD 110 to the frame 124. In the example in FIG. 4, the light shielding sheet 20 is a double sided adhesive sheet, and one of surfaces thereof (lower surface) is stuck over an upper surface of the optical sheets 18 and an upper surface of the frame 124. The other one of the surfaces thereof (upper surface) is stuck to the LCD 110.

For the light shielding sheet 20, a light shielding property is not necessarily demanded depending on required specifications, and if prevention of light leakage is not demanded, an adhesive sheet (adhesive tape) having a sticking function but not having a light shielding function may be used instead of the light shielding sheet 20. Thus, according to the present invention, those including a light shielding sheet, an adhesive sheet (adhesive tape), and the like will also be referred to as “adhesive sheets”.

As described above, the liquid crystal display device 100 has a configuration such that necessary components thereof are integrally held by the frame 124 arranged on the reverse surface side of the LCD 110, and necessary strength is secured. Not only in terms of functionality, such as downsizing of the liquid crystal display device 100, but also in terms of design, narrowing the frame of the liquid crystal display device 100 is always requested. In order to promote this frame narrowing, thickness of the frame 124 (dimensions illustrated with reference signs W₁ and W₂ in the example of FIG. 4) needs to be reduced. In this case, a sticking area on the upper surface of the frame 124 is reduced, and thus, as a technique for sufficiently securing a pasting margin for the light shielding sheet 20, a sticking range of the light shielding sheet 20 may be extended, not only over the upper surface of the frame 124 as illustrated in FIG. 4, but also to an outer surface of the frame 124 (see, for example, Japanese Laid-open Patent Publication No. 2005-243572).

Further, as a technique of narrowing the frame of the liquid crystal display device 100, a configuration has been developed, which uses a metal frame 126 (see FIG. 5) as the frame 124 (see, for example, Japanese Laid-open Patent Publication No. 2013-045559).

As described above, even if the sticking range of the light shielding sheet 20 is extended to the outer surface of the frame in order to deal with the reduction in the sticking area of the light shielding sheet 20 with respect to the frame upper surface due to the reduction in thickness of the frame, the following problem may be caused. An example in FIG. 5 illustrates a specific example, in which the metal frame 126 has been adopted as the frame, and the sticking range of the light shielding sheet 20 has been extended to an outer surface of the metal frame 126. In this case, when a position of the optical sheets 18 with respect to the metal frame 126 is displaced in a left-right direction in the figure within a dimensional tolerance range, the adhesive area between the optical sheets 18 and the light shielding sheet 20 may be reduced extremely. As a result, from a normal adhered state of the light shielding sheet 20 illustrated with a virtual line in the figure, the light shielding sheet 20 is brought into a state of being peeled off from the optical sheets 18, as illustrated with a solid line; without adhesive strength of the light shielding sheet 20 with respect to the optical sheets 18 being able to be sufficiently demonstrated.

This phenomenon of the light shielding sheet 20 being peeled off is caused by: the adhesive strength of the light shielding sheet 20 with respect to the optical sheets 18 losing to elastic return force of the light shielding sheet 20, and the light shielding sheet 20 standing up with its adhering portion to the outer surface of the metal frame 126 being a starting point; after the light shielding sheet 20 having a thin resin sheet as a base material is bent by being elastically deformed and is stuck so as to follow the outer surface of the metal frame 126 and the upper surface of the optical sheets 18.

When the light shielding sheet 20 is brought into the state of being peeled off from the optical sheets 18, not only fixing of the light shielding sheet 20 itself with respect to the planar illumination device 101 becomes uncomplete, but also fixing between the planar illumination device 101 and the LCD 110 via the light shielding sheet 20 becomes insufficient, making it difficult to form the liquid crystal display device 100, in which the planar illumination device 101 and the LCD 110 are integrated with each other via the light shielding sheet 20.

The present invention has been made in view of the above described problems, and an object thereof is to promote further frame narrowing of a planar illumination device and of a liquid crystal display device using the planar illumination device, and to more infallibly fix an adhesive sheet thereto.

### SUMMARY OF THE INVENTION

It is an object of the present invention to at least partially solve the problems in the conventional technology.

A planar illumination device according to an embodiment includes a light guiding plate, a light source, an optical sheet and a frame. The light guiding plate has one of a pair of opposite principal surfaces serving as a light emission surface. The light source is arranged at a side surface connecting end edges of the pair of principal surfaces of the light guiding plate. The optical sheet is arranged on a side of the emission surface of the light guiding plate. The frame is for positioning at least the light guiding plate.

The frame includes a side wall arranged along a side surface of the light guiding plate, and has an overlap portion formed therein, where the optical sheet and the side wall of the frame overlap each other at least partially in a planar view of the optical sheet, and where an upper end surface of the side wall is arranged below a lower surface of the optical sheet and covered by the optical sheet at least partially. The adhesive sheet is stuck over an upper surface of the optical sheet and an outer surface of the side wall.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a planar view of a planar illumination device according to an embodiment of the present invention;

FIG. 1B is an enlarged cross sectional view along an A-A line of FIG. 1A;

FIG. 1C is an enlarged cross sectional view along a B-B line of FIG. 1A;

FIG. 2 is a cross sectional view of main parts of a liquid crystal display device formed of a combination of the planar illumination device illustrated in FIG. 1 and an LCD;

FIG. 3A illustrates an application example of the planar illumination device according to the embodiment of the present invention, being a planar view thereof omitting a light shielding sheet for convenience;

FIG. 3B illustrates an application example of the planar illumination device according to the embodiment of the present invention, being a side view thereof;

FIG. 4 is a three dimensional cross sectional view illustrating main parts of a conventional liquid crystal display device; and

FIG. 5 is a cross sectional view illustrating main parts of a conventional planar illumination device.

### DETAILED DESCRIPTION OF THE PREFERRED EMBODIMENTS

Hereinafter, embodiments of the present invention will be described, based on the drawings. To portions that are the same as or portions corresponding to those of the conventional technique, the same reference signs will be appended and detailed description thereof will be omitted, as appropriate. Further, “upper” and “lower” directions in the following description mean upper and lower directions in a state where a planar illumination device and a liquid crystal display device in the description have been placed flatly. Furthermore, “outer” at each portion means the opposite side to a center portion of the devices in the state where the planar illumination device and the liquid crystal display device in the description have been placed flatly.

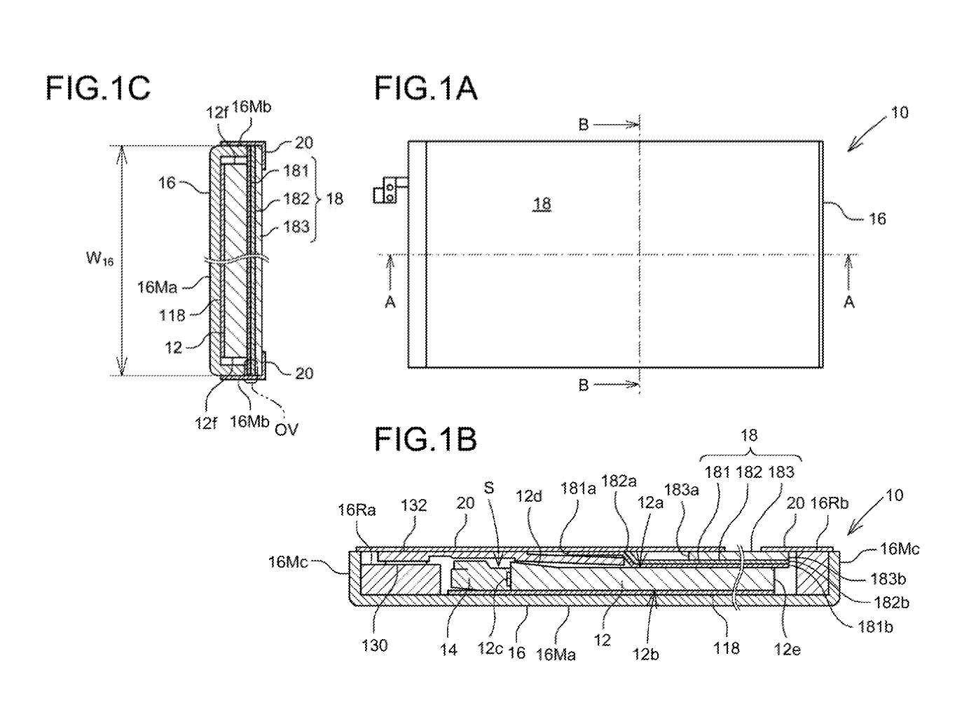

FIG. 1A, FIG. 1B and FIG. 1C illustrate a planar illumination device 10 according to an embodiment of the present invention. This planar illumination device 10 includes: a light guiding plate 12, which has a pair of principal surfaces 12a and 12b rectangular in a planar view and opposite to each other, and has one 12a of the principal surfaces 12a and 12b serving as a light emission surface; plural optical sheets 18 arranged by being layered over one another on the emission surface 12a; a light shielding sheet 20 (light shielding tape) prescribing an effective area of the emission surface 12a; an LED serving as a light source 14 (which is a point light source) arranged opposite to a light incident surface 12c, which is a surface where the light source 14 is arranged, the surface being of side surfaces connecting end edges of the pair of principal surfaces 12a and 12b; and a frame 16 for positioning these components.

In a range of a predetermined width towards a central portion from the light incident surface 12c, the range over the emission surface 12a of the light guiding plate 12, a sloped surface 12d is formed, which makes thickness between the pair of opposite principal surfaces thinner towards the central portion of the light guiding plate, and a range over the emission surface 12a, the range closer to the central portion than the sloped surface 12d, has a constant thickness.

A reflecting sheet 118 is fixed on a principal surface 12b side opposite to the emission surface 12a of the light guiding plate 12.

“Effective area” of the emission surface 12a prescribed by the light shielding sheet 20 is an area excluding a “non-effective area”, which is unavoidably generated near an end edge portion of the emission surface 12a of the light guiding plate 12, due to reduction in uniformity of emission light influenced by reflection of light at the side surface of the light guiding plate 12 or the like. The planar illumination device described herein maximally achieves effective utilization of the emission light from the effective area, by the non-effective area being covered and hidden by the light shielding sheet 20 in a planar view of the emission surface 12a of the light guiding plate 12. For convenience of explanation, in FIG. 1A, illustration of the light shielding sheet 20 is omitted.

The frame 16 is formed by sheet metal forming of a sheet material made of metal, such as aluminum alloy or stainless steel, and includes a bottom portion 16Ma, and a side wall arranged along the side surfaces 12c, and side surfaces 12e, and 12f of the light guiding plate 12. As this side wall, a first side wall 16Mb (see FIG. 1C) is formed, which stands up integrally with and from the bottom portion 16Ma, along each of the pair of side surfaces 12f connecting the end edges of the side surface of the light guiding plate 12 on a light incident surface 12c side with the end edges of the side surface 12e opposite to the light incident surface 12c. Further, a second side wall 16Mc (see FIG. 12) is formed, which stands up integrally with and from the bottom portion 16Ma, along each of the light incident surface 12c of the light guiding plate 12 and the side surface 12e opposite to the light incident surface 12c, at the bottom portion 16Ma of the frame 16. An abutting portion between the first side wall 16Mb and the second side wall 16Mc is continuous when the frame 16 is formed by drawing, and is divided when the frame 16 is formed by blanking and bending. Thickness of the bottom portion 16Ma is, for example, 0.1 mm to 0.2 mm. Further, thickness of the first side wall 16Mb and the second side wall 16Mc is also the same as that of the bottom portion 16Ma (for example, 0.1 mm to 0.2 mm). As appropriate, the second side wall 16Mc (see FIG. 1B) may be formed, which stands up integrally with and from the bottom portion 16Ma, along only one of the light incident surface 12c of the light guiding plate 12 and the side surface 12e opposite to the light incident surface 12c, at the bottom portion 16Ma of the frame 16.

Further, in the illustrated example, a pair of resin portions 16Ra and 16Rb are used in combination in the frame 16 made of sheet metal, the pair of resin portions 16Ra and 16Rb respectively opposite to the light incident surface 12c of the light guiding plate 12 and the side surface 12e opposite to the light incident surface 12c. The resin portions 16Ra and 16Rb are, for example, bar shaped members, having rectangular cross sections. By being formed of, preferably, white resin, these resin portions 16Ra and 16Rb reflect light leaking from the side surfaces 12c and 12e of the light guiding plate 12 opposite to the resin portions 16Ra and 16Rb efficiently to the light guiding plate 12, and contribute to increase in light emission efficiency from the principal surface 12a of the light guiding plate 12. The bottom portion 16Ma, the first side wall 16Mb and second side wall 16Mc, and the resin portions 16Ra and 16Rb, of the frame 16, are integrated with one another by insert molding. If the second side wall 16Mc is formed, from the bottom portion 16Ma of the frame 16, along only one of the light incident surface 12c of the light guiding plate 12 and the side surface 12e opposite to the light incident surface 12c; at a portion where the second side wall 16Mc does not exist, only the resin portion 16Ra or 16Rb exists as a side wall. Furthermore, the resin portions 16Ra and 16Rb are not essential to the configuration, and are arranged as appropriate.

As illustrated in FIG. 1C, the pair of side surfaces 12f of the light guiding plate 12, the side surfaces 12f connecting the end portions of the light incident surface 12c and the side surface 12e opposite to the light incident surface 12c, are arranged with a gap from the first side wall 16Mb. Further, in the illustrated example, as illustrated in FIG. 1B, the side surface 12e of the light guiding plate and the resin portion 16Rb are arranged with a gap therebetween. The light incident surface 12c of the light guiding plate 12 is adhered closely to the light source 14 basically, and the light source 14 and the resin portion 16Ra are arranged with a gap therebetween.

Further, according to this embodiment, the optical sheets 18 include a first sheet 181, which is the first one of layered stages as counted from the emission surface 12a of the light guiding plate 12, a second sheet 182 layered on the first sheet 181, and a third sheet 183 layered on the second sheet 182. For example, the first sheet 181 is a diffusion sheet, the second sheet 182 is a lower prism sheet, and the third sheet 183 is an upper prism sheet. These respective optical sheets 181, 182, and 183 are formed such that; in a state where end edge portions 181b, 182b, and 183b (see FIG. 1B) thereof on a side surface 12e side opposite to the light incident surface 12c are aligned with one another in a planar view thereof, the upper the stage of the optical sheet in the layered stages as counted from the emission surface 12a of the light guiding plate 12 is, the more separated the position of end edge portions 181a, 182a, or 183a on the light incident surface 12c side of the light guiding plate 12 is from the light incident surface 12c of the light guiding plate 12.

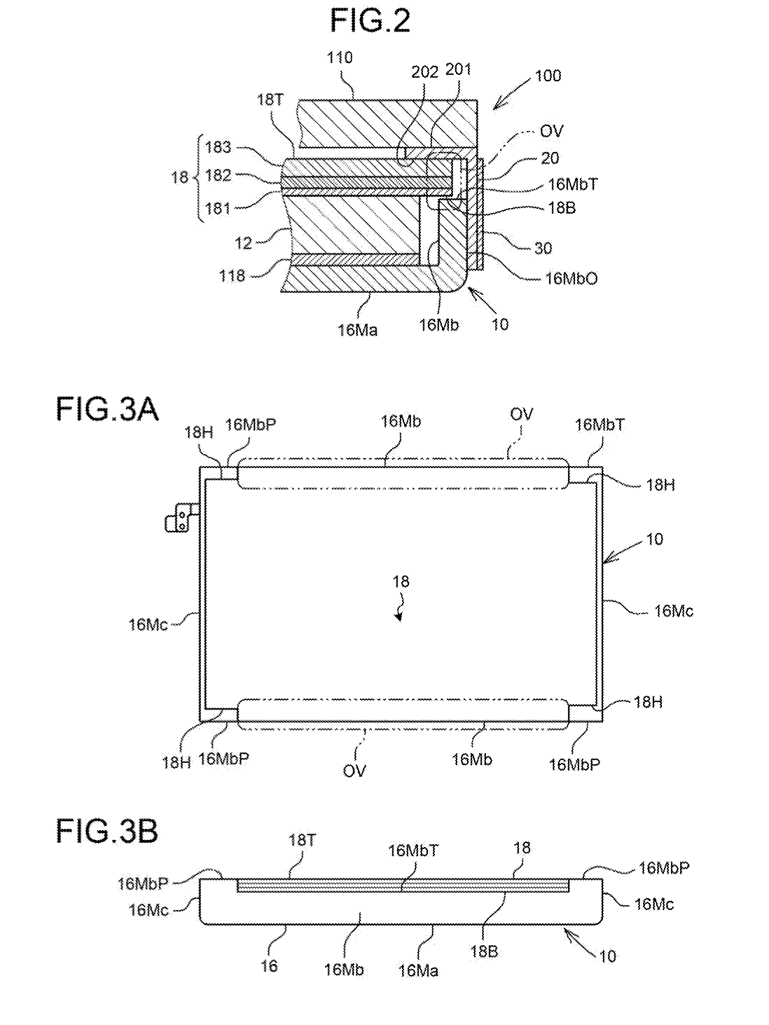

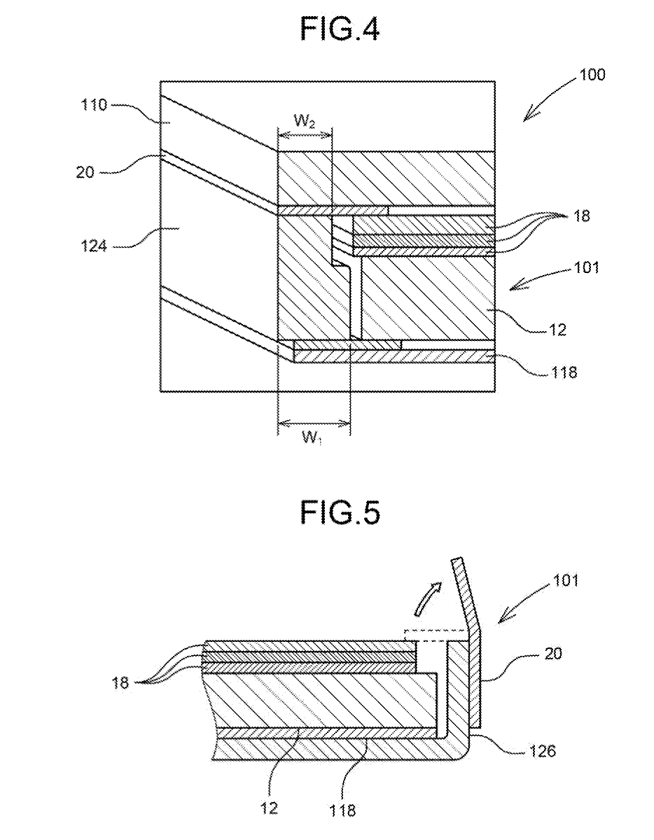

Further, as illustrated in FIG. 1C and FIG. 2, an overlap portion OV is formed, where the optical sheets 18 and the first side wall 16Mb of the frame 16 overlap each other at least partially in a planar view of the optical sheets 18. As illustrated in an enlarged view in FIG. 2, in this overlap portion OV, an upper end surface 16MbT of the first side wall 16Mb is arranged below a lower surface 18B of the optical sheets 18 (a lower surface of the first sheet 181 in the illustrated example, but limitation is not made thereto) and is covered by the optical sheets 18 at least partially. In FIG. 1C, a width dimension of the optical sheets 18 is illustrated as matching a width dimension W₁₆ between the first side walls 16Mb of the frame 16 of the planar illumination device 10, but, as illustrated in FIG. 2, the width dimension of the optical sheets 18 may be a width dimension, by which an end portion of the optical sheets 18 is partially over the upper end surface 16MbT of the first side wall 16Mb. Furthermore, in the example of FIG. 1C and FIG. 2, the first sheet 181, the second sheet 182, and the third sheet 183 are configured such that their end edge portions are aligned with one another in a planar view thereof and that they have the same width dimension, but they may have width dimensions such that only the third sheet 183 positioned on the uppermost stage covers, or the third sheet 183 and second sheet 182 cover, at least a part of the upper end surface 16MbT of the first side wall 16Mb.

The light shielding sheet 20 is stuck over an upper surface 18T of the optical sheets 18 and an outer surface 16MbO of the first side wall 16Mb. In FIG. 2, the light shielding sheet 20 is illustrated in a mode of being bent at right angles, but the light shielding sheet 20 may be stuck such that the light shielding sheet 20 is bent from a corner portion of the upper end surface 16MbT of the first side wall 16Mb towards a corner portion of the upper surface 18T of the optical sheets 18, and further bent to follow the upper surface 18T at the corner portion of the upper surface 18T of the optical sheets 18. In addition, a mode may be adopted, where the light shielding sheet 20 is stuck, as appropriate, without extending to the outer surface 16MbO of the first side wall 16Mb from the upper surface 18T of the optical sheets 18 (that is, the light shielding sheet 20 extends over a range of the upper surface 18T of the optical sheets 18 and up to the upper end surface 16MbT of the first side wall 16Mb). Further, in a bent portion of the light shielding sheet 20, perforations, a groove, or the like, may be provided to make the light shielding sheet 20 easy to be bent.

Moreover, in the example of FIG. 1B, the light shielding sheet 20 extends so as to cover the resin portion 16Ra from the second side wall 16Mc on the light incident surface 12c side of the light guiding plate 12, and further to cover a range up to near the end edge portion 183a of the optical sheet 183 of the uppermost stage, the end edge portion 183a on the light incident surface 12c side of the light guiding plate 12. Further, the light shielding sheet 20 is stuck to the resin portion 16Rb from the second side wall 16Mc on the side surface 12e side opposite to the light incident surface 12c of the light guiding plate 12, and further extends to cover a range up to near the end edge portion 183b of the optical sheet 183 of the uppermost stage. Furthermore, in contrast to the example in FIG. 1, if the resin portions 16Ra and 16Rb are not included along the second side wall 16Mc; at the second side wall 16Mc also, as illustrated in FIG. 2, the sticking range of the light shielding sheet 20 may be increased up to the outer surface of the second side wall 16Mc.

A wiring board 132 of the light source 14 is fixed with a double sided tape 130, to an upper surface of the resin portion 16Ra of the frame 16.

As the light shielding sheet 20, one like a so-called double sided tape is widely used in general, the double sided tape having adhesive layers on both a first surface 201 thereof opposite to the LCD 110 and a second surface 202 thereof opposite to the light guiding plate 12. In the example of FIG. 2, a film 30 to cover and hide the adhesive layer on an outer surface (first surface 201) of the light shielding sheet 20 is used, the outer surface of a portion arranged on the outer surface 16MbO of the first side wall 16Mb. By this film 30, in a state where the light shielding sheet 20 is fixed to the outer surface 16MbO of the first side wall 16Mb, the adhesive layer of the light shielding sheet 20 impeding handling (carrying) of the planar illumination device 10 is covered and hidden, and necessary handling ability is ensured.

Although illustration thereof is omitted, if a light shielding sheet not having an adhesive layer is used in the range over which the film 30 is stuck in FIG. 2, that is, on a surface of the portion arranged on the outer surface 16MbO of the first side wall 16Mb, the portion of the first surface 201 of the light shielding sheet 20; without use of the film 30, handling ability similar to that of the example in FIG. 2 is able to be ensured.

Further, as illustrated in FIG. 3, a projecting portion 16MbP projecting higher than the lower surface 18B of the optical sheets 18 may be formed on the upper end surface 16MbT of the first side wall 16Mb, and a notched portion 18H having a shape complementary to that of the projecting portion 16MbP may be formed in the optical sheets 18. The projecting portion 16MbP in the example of FIG. 3 is configured such that a height of its portion of the first side wall 16Mb connected with the second side wall 16Mc has been increased, together with the second side wall 16Mc, up to the same height as the upper surface 18T of the optical sheets 18, but not being limited thereto, the projecting portion 16MbP may have a projecting shape that is column shaped or prism shaped.

By the embodiment of the present invention configured as described above, the following effects are able to be obtained.

That is, in the overlap portion OV between the first side wall 16Mb of the frame 16 and the optical sheets 18, the upper end surface 16MbT of the first side wall 16Mb is arranged below the lower surface 18B of the optical sheets 18, and the upper end surface 16MbT of the first side wall 16Mb is covered by the optical sheets 18 at least partially. Therefore, even if a sticking margin for the light shielding sheet 20 is unable to be sufficiently secured on the upper end surface 16MbT of the first side wall 16Mb, a sticking margin for the light shielding sheet 20 is sufficiently secured on an optical sheet 18 side, the light shielding sheet 20 arranged over the upper surface 18T of the optical sheets 18 and the outer surface 16MbO of the first side wall 16Mb. Therefore, regardless of the thickness of the first side wall 16Mb (the width of the upper end surface 16MbT) due to promotion of reduction in thickness of the first side wall 16Mb, a problem (see FIG. 5) is avoided, the problem of fixing of the light shielding sheet 20 becoming incomplete by adhesive strength of the light shielding sheet 20 with respect to the optical sheets 18 losing to elastic return force of the light shielding sheet 20 and the light shielding sheet 20 standing up with its adhering portion to the outer surface 16MbO of the first side wall 16Mb of the frame 16 being a starting point.

According to this configuration, the end surface of the optical sheets 18 is exposed towards outside of the first side wall 16Mb by being positioned above the upper end surface 16MbT of the first side wall 16Mb without being covered by the first side wall 16Mb of the frame 16, but the exposed end surface of the optical sheets 18 is covered and hidden by the light shielding sheet 20, which is arranged over the upper surface 18T of the optical sheets 18 and the outer surface 16MbO of the first side wall 16Mb. Therefore, light leakage from the end surface of the optical sheets 18 to the outside is not caused, either.

Further, since the first side wall 16Mb of the frame 16 for positioning the components of the planar illumination device 10 is arranged along each of the pair of side surfaces 12f of the side surfaces of the light guiding plate 12, the pair of side surfaces 12f connecting the end edges of the light incident surface 12c where the light source 14 is arranged, with the end edges of the side surface 12e opposite to the light incident surface 12c; in advancing frame narrowing of the planar illumination device at this pair of side surfaces 12f, the above described effects are obtained.

Furthermore, by the second side wall 16Mc being arranged along at least one of the light incident surface 12c of the light guiding plate 12 and the side surface 12e opposite to the light incident surface 12c; together with the first side wall 16Mb, the components, such as the light guiding plate 12, light source 14, and optical sheets 18, are able to be infallibly held along the three side surfaces (12c or 12e; and 12f and 12f) or four side surfaces (all of 12c, 12e, 12f, and 12f) of the light guiding plate 12 by these first side wall 16Mb and second side wall 16Mc. As necessary, in advancing frame narrowing of the planar illumination device 10 at at least one of the light incident surface 12c of the light guiding plate 12 and the side surface 12e opposite to the light incident surface 12c, the above described effects are obtained. In particular, request for frame narrowing of the planar illumination device 10 along the side surface 12e opposite to the light incident surface 12c is able to be met.

Further, as exemplified by FIG. 1, by the first side wall 16Mb being formed of sheet metal, without reduction in thickness being limited in terms of formability like a frame obtained by injection molding or the like of a synthetic resin material, reduction in thickness of the first side wall 16Mb and second side wall 16Mc of the frame 16 is able to be promoted and the above described effects are able to be obtained.

Further, in the example of FIG. 1, by the frame 16 including the resin portions 16Ra and 16Rb between: the light incident surface 12c of the light guiding plate 12 and the side surface 12e opposite to the light incident surface 12c; and the second side wall 16Mc, holding and positioning of the components of the planar illumination device 10, such as the light guiding plate 12 and the optical sheets 18, are achieved by these resin portions 16Ra and 16Rb. If the side walls 16Mb and 16Mc of the frame 16 are sheet metal parts, a sticking margin for the light shielding sheet 20 is able to be secured in the resin portion 16Rb as illustrated in FIG. 1B. Furthermore, occurrence of contamination in the portion is able to be lessened, the contamination caused by the second side wall 16Mc contacting the light guiding plate 12 or the like when the component of the planar illumination device 10, such as the light guiding plate 12, is assembled and positioned onto the frame 16 (supposing the case where the resin portions 16Ra and 16Rb are not present). Moreover, the resin portion 16Ra, in particular, ensures insulation between the metal portion and the wiring board 132 of the light source 14. In addition, when the resin portion 16Rb is arranged at the side surface 12e opposite to the light incident surface 12c of the light guiding plate 12, reflection of light leaking from this side surface 12e, towards the light guiding plate 12 by the resin portion 16Rb opposite to this side surface 12e contributes to increase in light emission efficiency from the principal surface 12a of the light guiding plate 12.

Further, by the frame 16 including the bottom portion 16Ma in addition to the first side wall 16Mb and second side wall 16Mc, lateral positioning of the components of the planar illumination device 10, such as the light guiding plate 12 and the optical sheets 18, is achieved by the first side wall 16Mb and second side wall 16Mc in a state where the components are supported by the bottom portion 16Ma from therebelow. That is: the height direction positions of the upper surface 18T of the optical sheets 18 and the upper end surface 16MbT of the first side wall 16Mb are determined by the bottom portion 16Ma; the height direction position of the light shielding sheet 20, which is arranged over the upper surface 18T of the optical sheets 18 and the outer surface 16MbO of the first side wall 16Mb, is also more accurately determined; and fixing between the optical sheets 18 and the frame 16 is infallibly achieved by the light shielding sheet 20.

In addition, the projecting portion 16MbP, which is provided on the upper end surface 16MbT of the first side wall 16Mb and projects higher than the lower surface 18B of the optical sheets 18, is avoided by the notched portion 18H formed in the optical sheets 18, and thus the projecting portion 16MbP of the first side wall 16Mb, the projecting portion 16MbP projecting higher than the lower surface 18B of the optical sheets 18, does not overlap the optical sheets 18 in a planar view thereof. Therefore, the overlap portion OV is not formed in this characteristic portion (the portion where the projecting portion 16MbP projecting higher than the lower surface 18B of the optical sheets 18 is formed on the upper end surface 16MbT of the first side wall 16Mb, and a notched portion 18H having a shape complementary to that of the projecting portion 16MbP is formed in the optical sheets 18). Since the surface orientation positioning of the optical sheets 18 with respect to the frame 16 is achieved by the projecting portion 16MbP formed on the upper end surface 16MbT of the first side wall 16Mb and the notched portion 18H of the optical sheets 18, positional displacement of the optical sheets 18 with respect to the first side wall 16Mb is prevented, the overlap portion OV is infallibly formed at the place excluding this characteristic portion, and the above described effects are able to be obtained infallibly.

In the liquid crystal display device 100 (see FIG. 2) according to the embodiment of the present invention, by the liquid crystal display panel 110 layered on the emission surface 12a side of the light guiding plate 12 of the planar illumination device 10 being illuminated by the planar illumination device 10, a so-called back light type liquid crystal display device is formed. What is more, in the configuration where the liquid crystal display panel 110 and the planar illumination device 10 are fixed via the light shielding sheet 20, positional displacement due to adhesive failure of the light shielding sheet 20 is hard to be caused, and operability upon assembly is improved.

Although detailed description thereof will be omitted, it should be understood that application of the present invention to a planar illumination device including the frame 16, which is for example, formed only of resin, formed only of sheet metal (metal), or is frame shaped without a bottom portion, achieves effects similar to those of the embodiment.

In addition, in order to increase the emission efficiency from the light guiding plate 12, white ink, silver, or the like may be coated on an inner surface (a surface facing the light guiding plate 12) of the sheet metal frame.

Since the present invention is configured as described above, further frame narrowing in a planar illumination device, and in a liquid crystal display device using the planar illumination device, is able to be promoted, and an adhesive sheet is able to be more infallibly fixed thereto.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A planar illumination device including: a light guiding plate having one of a pair of opposite principal surfaces serving as a light emission surface; a light source arranged at a side surface connecting end edges of the pair of principal surfaces of the light guiding plate; an optical sheet arranged on a side of the light emission surface of the light guiding plate; and a frame for positioning at least the light guiding plate, wherein
the frame includes a side wall arranged along a side surface of the light guiding plate, and has an overlap portion formed therein, where the optical sheet and the side wall of the frame overlap each other at least partially in a planar view of the optical sheet, and where an upper end surface of the side wall is arranged below a lower surface of the optical sheet and covered by the optical sheet at least partially and
an adhesive sheet is stuck over an upper surface of the optical sheet and an outer surface of the side wall.

2. The planar illumination device according to claim 1, wherein the side wall is arranged along each of a pair of side surfaces of the light guiding plate, the pair of side surfaces connecting end edges of a light incident surface at which the light source is arranged with end edges of a side surface opposite to the light incident surface.

3. The planar illumination device according to claim 2, wherein the side wall is arranged also along at least one of the light incident surface and the side surface opposite to the light incident surface, of the light guiding plate.

4. The planar illumination device according to claim 1, wherein the side wall is formed of sheet metal.

5. The planar illumination device according to claim 4, wherein the frame includes a resin portion between the side wall and at least one of the light incident surface and a side surface opposite to the light incident surface, of the light guiding plate.

6. The planar illumination device according to claim 1, wherein the frame includes a bottom portion.

7. The planar illumination device according to claim 1, wherein a projecting portion projecting higher than the lower surface of the optical sheet is formed on the upper end surface of the side wall and a notched portion having a shape complementary to that of the projecting portion is formed in the optical sheet.

8. A liquid crystal display device, comprising:
a planar illumination device including: a light guiding plate having one of a pair of opposite principal surfaces serving as a light emission surface; a light source arranged at a side surface connecting end edges of the pair of principal surfaces of the light guiding plate; an optical sheet arranged on a side of the light emission surface of the light guiding plate; and a frame for positioning at least the light guiding plate; and
a liquid crystal panel arranged on the side of the light emission surface of the light guiding plate and fixed to the planar illumination device via an adhesive sheet, wherein
the frame includes a side wall arranged along a side surface of the light guiding plate, and has an overlap portion formed therein, where the optical sheet and the side wall of the frame overlap each other at least partially in a planar view of the optical sheet, and where an upper end surface of the side wall is arranged below a lower surface of the optical sheet and covered by the optical sheet at least partially and
the adhesive sheet is stuck over an upper surface of the optical sheet and an outer surface of the side wall.
